(19) United States
(12) Patent Application Publication
(10) Pub. No.: US 2007/0159465 A1
(43) Pub. Date: Jul. 12, 2007

(54) Span and angle adjustable keyboard for an abnormally big body size user

(76) Inventor: Samuel Choi, La Palma, CA (US)

Correspondence Address: Eugene Oak, Ph.D., J.D., M. Div.;Law Office of Jane Oak & Associates, P.C., Suite # 2470, Wilshire Blvd., Los Angeles, CA, 90010, US

(21) Appl. No.: 11/328,214

(22) Filed: Jan. 10, 2006

(51) Int. Cl. G06F 3/02

(52) U.S. Cl. 345/168

(57) ABSTRACT

A keyboard for an information processing machine, such as personal computer, is designed so that each alphanumeric key has a rectangular upper surface of 17 mm to 20 mm in width and 20 mm to 25 mm in length. The distance between the upper surfaces of each key is set as 6 to 10 mm. These sizes are bigger than an average key board to allow an easy operation by a user with bigger body. The keyboard has actuators thereon arranged in a conventional keyboard distribution. But, the whole keyboard set is separated into two pieces of equal size and has apparently different configuration. One upper corner of each piece of the keyboard is pivotally connected to one end of a metal arm with a pivot joint. The other ends of two metal arms are connected each other via another pivot joint. This configuration enables a user adjusting the angle and span between the two pieces of a keyboard to maintain a more comfortable position than using conventional keyboard. A document to be typed can be placed between the two pieces of the keyboard of the current application.

### FIELD OF THE INVENTION

Current application is regarding a keyboard having apparently different configuration, especially a keyboard having alphanumeric keys bigger than conventional key and the whole keyboard is separated into two pieces of same size.

### BACKGROUND OF THE INVENTION

Most of the conventional keyboard for computer has standard key size and overall board size. But, for some users having big body size, conventional keyboard is too small and narrow. Therefore, frequent input error happens and the big user must fold the shoulders in. In addition to these uncomfortable situations, the user must distort wrists of both hands to match the configuration of a conventional keyboard. Though some keyboards have partial annular shape to avoid such distorted hand position, the width of the keyboard is fixed and there is limit to use for big body size users. Another limitation of all the previous key boards is that user must put a document, to be typed or to be input to the machine, beside of the keyboard or monitor screen with additional supplementary tool. So the user must turn the head aside, distort wrists, fold the shoulders in and look in the keyboard to avoid mistyping. Such working environment due to the arrangement of a conventional keyboard induces stress and tension. It is purpose of the current application to remove all the drawbacks of the previous keyboards and to provide a convenient-to-use keyboard for a big body size user.

### DESCRIPTION OF THE PRIOR ARTS

U.S. Pat. No. 4,661,005 to Lahr illustrates a split able keyboard arrangement for reducing stress and tension experienced by a human operator during communication with an information processing machine. The keyboard is split able into first and second sections, each such section containing respective portions of the actuators. When joined, the two keyboard sections form a unitary keyboard which is conventional in appearance and operation. When separated, a display screen may be interposed between the keyboard sections, and the keyboard sections may be arranged in selectable spatial positions and orientations selected for the comfort of the operator. An adjustable mechanical mounting arrangement is provided for ensuring positional stability of the keyboard sections. However, this invention does not resolve distortion of the wrist of a user and can not reduce the typing error due to the thick fingers of a big body size user.

U.S. Pat. No. 4,509,873 to Ryan illustrates an adjustable alphanumeric keyboard consisting of two flat key contact mounting boards, one left and one right, corresponding respectively to the section of the alphanumeric keyboard actuated by the left hand and right hand in touch typing, joined by a hinge at a point corresponding to the keyboard C row, between columns 05 and 06, the outermost end of one mounting board connected by a hinge to the keyboard case or chassis, the outermost end of the other mounting board free to move laterally and pivot in the same plane, with means available to position said movable end, in order to give the mounting boards an adjustable angle, peaking the rows of key contacts between columns 05 and 06. However, it does not provide a space wide enough for a big body size user.

U.S. Pat. No. 4,378,553 to McCall illustrates an electromechanical interactive terminal system utilizing a split keyboard to accommodate convenient use, even by disabled or infirm persons. The elements of a conventional typewriter (or console) keyboard are provided in two separate and distinct keyboard units, one of which includes the keys normally activated by the right hand while the other has the keys conventionally assigned for use by the left hand. Control and coding keys are similarly assigned. The two separate keyboard units can be used in various positions as by being affixed to a support member so as to be held in spaced-apart relationship, contiguous to the hands of an operator with his arms apart and supported at rest. The keyboard units each incorporate electrical apparatus for providing electrical signals representative of data symbols associated with the keys. This invention provides a space between two pieces of keyboard. But, can not resolve problems that big body size users meet.

U.S. Pat. No. 4,330,776 to Dennison, Jr., illustrates an input control that includes first and second keyboard assemblies mounted on a common structural unit, an encoder on the unit, and a plurality of output conductors connected to the encoder for transmitting a binary coded signal when a key is actuated. The structural unit is mounted for rotation between an upright position in which only the first keyboard assembly is operator accessible and an inverted position in which only the second keyboard assembly is operator accessible.

None of the prior art illustrates a keyboard designed to provide a convenient working atmosphere to a user having big body size.

### SUMMARY OF THE INVENTION

Most of the conventional keyboard for computer has standard key size and overall board size. But, for some users having big body size, conventional keyboard is too small and narrow. Therefore, frequent input error happens and the big user must fold the shoulders in. In addition to these uncomfortable situations, the user must distort wrists of both hands to match the configuration of a conventional keyboard. It is purpose of the current application to provide a key board that enables big body size users work without suffering from un-matching size of conventional keyboards. A keyboard for an information processing machine, such as personal computer, is designed so that each key has a square upper surface of 17 mm to 20 mm in width and length. The distance between the upper surfaces of each key is set as 10 to 13 mm. These sizes are bigger than an average key board to allow an easy operation by a user with bigger body. The keyboard has actuators thereon arranged in a conventional keyboard distribution. But, the whole keyboard set is separated into two pieces of equal size. Therefore has apparently different configuration. One upper corner of each piece of the keyboard is pivotally connected to one end of a metal arm with a pivot joint. The other ends of two metal arms are connected each other via another pivot joint. This configuration enables a user adjusting the angle and span between the two pieces of a keyboard to maintain a more comfortable position than using conventional keyboard. A document to be typed can be placed between the two pieces of the keyboard of the current application.

### BRIEF DESCEIPTION OF THE DRAWINGS

FIG. 1 is an over view of the span and angle adjustable keyboard for a big body size user of the current application.

FIG. 2 is a schematic drawing of side view when a user having average finger thickness presses keys of a conventional keyboard.

FIG. 3 is a schematic drawing of side view when a user of having abnormally thick fingers press keys of a conventional keyboard.

FIG. 4 is an enlarged front view of keys of the keyboard of the current application.

FIG. 5 is a rear view of the span and angle adjustable keyboard for a big body size user of the current application.

FIG. 6 is a schematic drawing of the span and angle adjustable keyboard for a big body size user of the current application in use combined with a personal computer.

### DETAILED DESCRIPTION OF THE PREFERRED EMBODIMENT

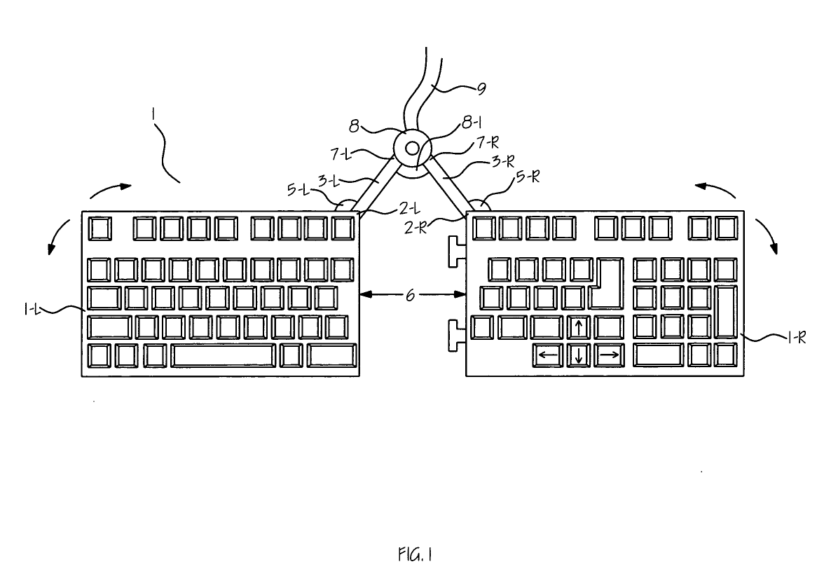

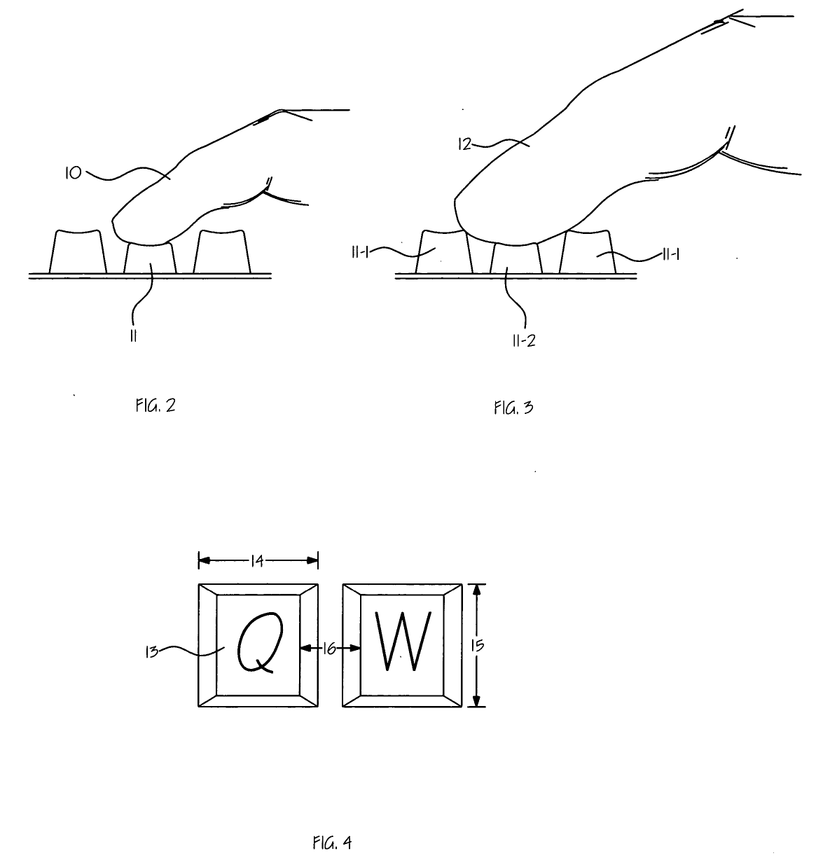

FIG. 1 is an over view of the span and angle adjustable keyboard (1) for a big body size user of the current application. The keyboard (1) of the current application has key arrangement same as conventional keyboard such as ‘QWERTY’. The keyboard (1) of the current application is divided into two pieces of equal size, left piece(1-L) and right piece (1-R), named by a front view. Therefore has apparently different configuration. Right upper corner (2-L) of the left piece (1-L) and left upper corner (2-R) of the right piece (1-R) of the keyboard are pivotally connected to one end of each metal arms (3-L), (3-R) with a small pivot joint, respectively ((4-R) and (4-L) in FIG. 2). Each of the small pivot joint (4-R) and (4-L) allows rotation of the right piece (1-R) and the left piece (1-L) around each small pivot joint and make the angle (5-L) and (5-R), the angle between each piece of the keyboard and the metal arm, change from 15 degree to 345 degree. The other ends (7-L), (7-R) of two metal arms are connected each other via another large pivot joint (8). The angle (8-1) between the metal arms is adjusted from 5 degree to 300 degree by the large pivot joint (8). This configuration enables an user adjusting the angle (5-R) and (5-L) and span (6) between the two pieces (1-R), (1 -L) of a keyboard to maintain a more comfortable position than using conventional keyboard. Connecting wires from the keyboard (1) to a personal computer, for example, pass through inside of two metal arms (3-L), (3-R), gathered inside of a flexible plastic tube (9) and then connected to a computer main body. One end of the flexible plastic tube (9) is connected to the large pivot joint (8) and the other end is connected to the main body of a computer (not shown in the Figure).

FIG. 2 is a schematic drawing of side view when a user having average finger (10) thickness presses keys (11) of a conventional keyboard. Keys (11) of conventional keyboard have standard shape and size. The keys (11) have concave surface to meet finger tip of a user. The keys' front face has rectangular shape. Most of the keys have 12 mm in horizontal length and 14 mm in vertical length. The distance between the neighboring front surfaces is about 6 mm. Meanwhile, width of mid-finger of average adult women is 13 to 15 mm and adult men is 18 to 20 mm. Therefore, most of adult's finger thickness is within the limit of 24 mm, which is the summation of the spaces of left and right side of a key, 6 mm+6 mm, and the width of the key 12 mm. But, some adult men have fingers thicker than 24 mm. If the finger thickness is larger than 24 mm, it is almost impossible to type one key alone.

FIG. 3 is a schematic drawing of side view when a user of having abnormally thick fingers (12) press keys (11) of a conventional keyboard. When a user, having finger thickness wider than 22 mm, press a specific key (11-1) of a conventional keyboard, keys (11-2) located just next to the specific key (11-1) are pressed too. Then input error happens and make the user nervous.

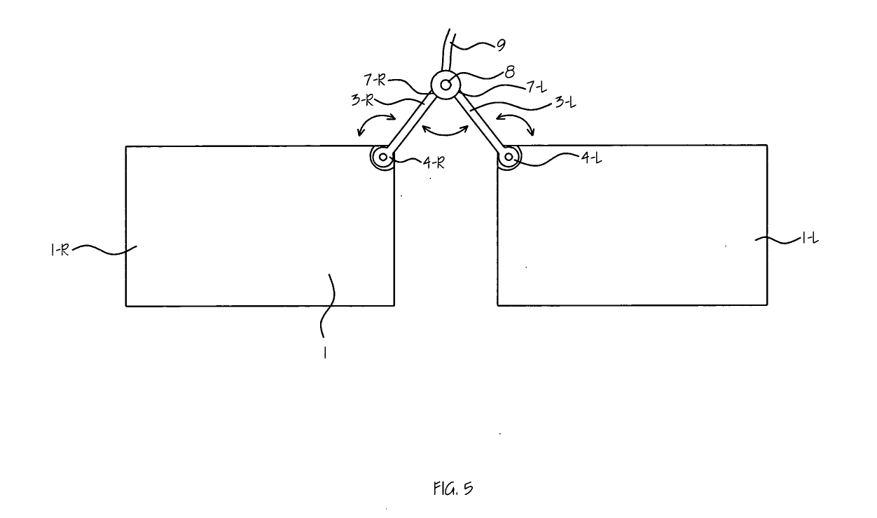

FIG. 4 is an enlarged view of keys (13) on the keyboard (1) of the current application. The apparent shape of keys (13) on the keyboard (1) of the current application is the same as the shape of the keys (11) on conventional keyboard. The only difference is the size. The horizontal length (14), width, of the key (13) is in the range of 17 mm to 20 mm. The vertical length (15) of the key (13) is in the range of 20 mm to 25 mm. The distance (16) between the upper surfaces of each key is set as 6 to 10 mm.

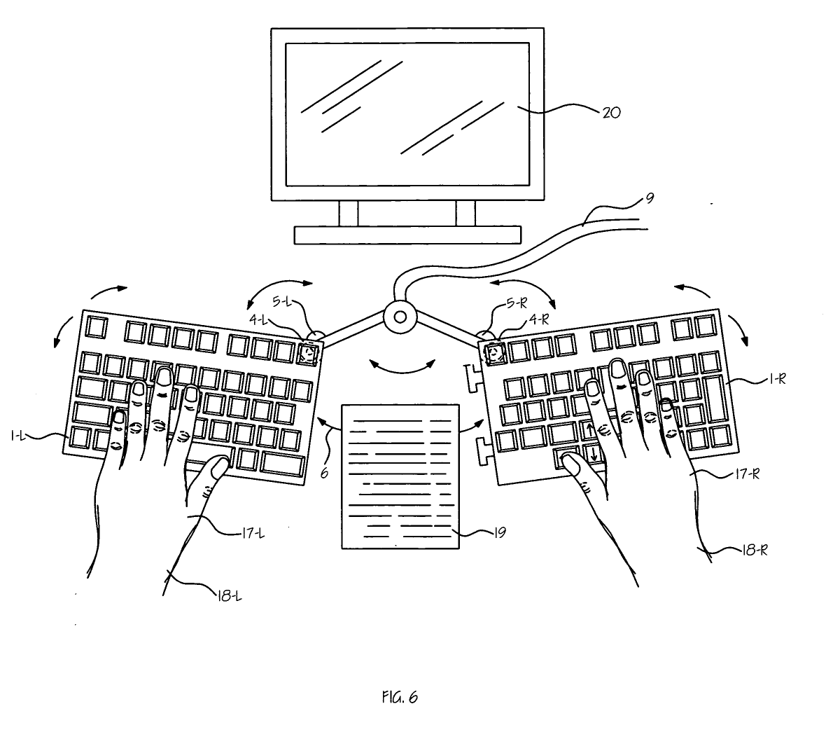

FIG. 5 is a rear view of the span and angle adjustable keyboard (1) for a big body size user of the current application. One upper corner (2-L), (2-R) of each piece (1-L), (1-R) of the keyboard is pivotally connected to one end of a metal arm (3-L), (3-R) with a pivot joint ((4-R) and (4-L)). The other ends (7-L), (7-R) of two metal arms are connected each other via another pivot joint (8). Connecting wires from the keyboard (1) to a personal computer, for example, pass through inside of two metal arms (3-L), (3-R), gathered inside of a plastic tube (9) and then connected to a computer main body.

FIG. 6 is a schematic drawing of the span and angle adjustable keyboard (1) for an abnormally big body size user of the current application in use combined with a personal computer. First of all, the span (6) between the two pieces (1-L), (1-R) is adjusted to the upper body size of a user by stretching the metal arms (3-L), (3-R). And the angles (5-L), (5-R) are also adjusted by turning the pieces (1-L) and (1-R) around the pivot joints (4-L) and (4-R). Then the two hands (17-L), (17-R) of the user positioned on the two pieces (1-L), (1-R) of the keyboard (1) without distorting the wrists from the each arms (18-L), (18-R). Then the user needs not to fold the shoulders in and need not to distort the wrists. In addition to that the user can put an article (19), to be typed, on the space between the two pieces (1-L), (1-R) of the keyboard (1) and type while looking at the screen monitor (20) of a personal computer. Then the user needs to turn his/her neck to read an article to be typed in.

It is clear that applying flexible plastic tubes instead of the metal arms (3-L), (3-R) can provide similar effect without using pivot joints.

What is claimed is:

1. A keyboard for a personal computer to enable a user of abnormally large body size use it without any inconvenience is comprised of:
a keyboard which is divided into two pieces of left piece and right piece of equal size, and
pluralities of alphanumeric keys having horizontal length in the range of 17 mm to 20 mm, vertical length in the range of 20 mm to 25 mm and having distance between the upper surfaces of each key in the range of 6 to 10 mm, and
two small pivot joints, one of which is placed on the left upper corner of the right piece and the other is placed on the right upper corner of the left piece of the keyboard respectively, and
two metal arms, one end of each is pivotally connect to one of the pivot joint to adjust the angle between one metal arm and one piece of the keyboard from 15 degree to 345 degree, and
a large pivot joint which connects the other ends of the two metal arms and adjusts the angle between the metal arms from 5 degree to 300 degree, and
a flexible plastic tube one end of which is connected to the large pivot joint and the other end is connected to the main body of a computer.
